(19) United States
(12) Patent Application Publication
(10) Pub. No.: US 2004/0115338 A1
(43) Pub. Date: Jun. 17, 2004

(54) Manufacturing method of organic electroluminescent display device

(75) Inventor: Kiyoshi Yoneda, Motosu-gun (JP)

Correspondence Address: Barry E. Bretschneider, Suite 300, 1650 Tysons Boulevard, McLean, VA, 22102, US

(73) Assignee: Sanyo Electric Co., Ltd., Moriguchi-shi (JP)

(21) Appl. No.: 10/653,420

(22) Filed: Sep. 3, 2003

(30) Foreign Application Priority Data
Sep. 5, 2002 (JP) 2002-259649
Sep. 5, 2002 (JP) 2002-259650

(51) Int. Cl. B05D 5/12

(52) U.S. Cl. 427/66; 427/68; 427/248.1

(57) ABSTRACT

A vapor-depositing mask is disposed adjacent a surface of a substrate disposed in a vacuum chamber, vapor-depositing beams containing an organic EL material are generated by a vapor-depositing beam generator, the vapor-depositing beams pass through openings in the vapor-depositing mask, and the organic EL material is vapor-deposited in a predetermined region on the surface of the substrate. The vapor-depositing beams are guided through a plurality of vapor-depositing beam passing pipes provided in the vapor-depositing beam generator. Alternatively, the vapor-depositing beams generated by the vapor-depositing beam generator are guided through a vapor-depositing beam direction adjusting board having a plurality of vapor-depositing beam passing holes. This enhances directional uniformity of the vapor-depositing beams, thereby enabling making each film thickness of organic EL material layers uniform and thus enhancing precision of forming patterns of the layers.

### BACKGROUND OF THE INVENTION

1. Field of the Invention

The present invention relates to a manufacturing method of an electroluminescent display device, particularly to a vapor-deposition process of an organic electroluminescent material.

2. Description of the Related Art

In recent years, organic electroluminescent (hereafter, referred to as organic EL) display devices with an organic EL element have been receiving an attention as a display device substituting for a CRT and an LCD. For example, research and development are being pursued for the organic EL display device provided with a thin film transistor (hereafter, referred to as TFT) as a switching element for driving the organic EL element.

FIG. 11 is a cross-sectional view of a pixel of the organic EL display device. This pixel has a TFT for driving the organic EL element disposed in a periphery of an intersection of a gate signal line having a gate electrode 11 and a drain signal line (not shown). A drain of the TFT is connected to the drain signal line, the gate electrode 11 is connected to the gate signal line (not shown), and a source 13s is connected to an anode 61 of the EL element. In the EL display device, a plurality of the pixels is disposed in a matrix to form a display region. A manufacturing method of this organic EL display device will be described hereinafter.

A pixel is formed by sequentially laminating the TFTs and the organic EL element on a transparent insulating substrate 10 made of glass or synthetic resin. First, the gate electrode 11 made of a metal having a high melting point such as Cr (chromium) is formed on the insulating substrate 10, and a gate insulating film 12 and an active layer 13 made of a p-Si film are sequentially formed thereon.

In the active layer 13, a channel 13c is formed above the gate electrode 11. The source 13s and the drain 13d, each of which is formed of a low impurity concentration region and a high impurity concentration region on the outside of the low impurity concentration region, are formed on each side of this channel 13c in the active layer 13. The source 13s and the drain 13d are formed on each side of the gate electrode 11 by ion doping with a stopper insulating film 14 as a mask above the channel 13c and further ion doping with covering each sides of the gate electrode 11 by a resist.

An interlayer insulating film 15 formed by sequentially laminating a SiO2 film, a SiN film, and a SiO2 film covers the whole surfaces of the gate insulating film 12, the active layer 13, and the stopper insulating film 14. A drain electrode 16 is formed by filling tithe a metal such as Al (aluminum) a contact hole provided correspondingly to the drain 13d. A planarization insulating film 17 for planarizing a surface and made of, for example, an organic resin, is formed on the whole surfaces.

A contact hole is formed in a position corresponding to the source 13s in the planarization insulating film 17. An anode 61 made of ITO (indium tin oxide), which contacts the source 13s through the contact hole and serves as a source electrode, is formed on the planarization insulating film 17. The anode 61 is made of a transparent electrode such as ITO.

The organic EL element 60 has a general structure of laminating sequentially the anode 61, a hole transport layer 62 formed of a first hole transport layer made of MTDATA (4,4-bis (3-methylphenylphenylamino) biphenyl) and a second hole transport layer made of TPD (4,4,4-tris (3-methylphenylphenylamino) triphenylanine), an emissive layer 63 made of Bebq2 (bis(10-hydroxybenzo[h]quinolinato)beryllium) containing a quinacridone derivative, an electron transport layer 64 made of Bebq2 and a cathode 65 made of magnesium-indium alloy, aluminum or aluminum alloy.

The organic EL element 60 emits light by an electric current supplied through the above TFT for driving the organic EL element. That is, holes injected from the anode 61 and electrons injected from the cathode 65 are recombined in the emissive layer 63 and excitons are formed by exciting organic molecules of the emissive layer 63. Light is emitted from the emissive layer 63 in a process of radiation of the excitons and then released outside after going through the transparent anode 61 to the transparent insulating substrate 10, thereby to complete light-emission.

Since organic EL materials used for the above described hole transport layer 62, emissive layer 63, and electron transport layer 64, which form the organic EL element 60, have a low solvent resistance and is sensitive to moisture, the photolithography in a manufacturing process of a semiconductor can not be used. Therefore, a vapor-deposition method with a so-called shadow mask is used for pattern formation of the hole transport layer 62, the emissive layer 63, the electron transport layer 64, and the cathode 65, which form the organic EL element 60.

The related art is disclosed in Japanese Laid-open Patent Application No. 2001-175200.

When forming the pattern of the organic EL element 60 by the above described vapor-deposition method with the shadow mask, the shadow mask 101 is disposed adjacent a surface of the insulating substrate 100, as shown in FIG. 12A. This is because a contact between the shadow mask 101 and the insulating substrate 100 provides a possibility of damaging the surface of the insulating substrate 100.

Vapor-deposition beams 103 containing an organic EL material, which are generated by a vapor-deposition beam generator (not shown), are led to the insulating substrate 100 through openings 102 provided in the shadow mask 101. Then, as shown in FIG. 12B, the organic EL material is vapor-deposited in a region corresponding to the openings 102 on the surface of the insulating substrate 100.

If the directional uniformity, or collimation, of the vapor-deposition beams is low, however, a shadow effect occurs to provide oblique components of the vapor-deposition beams from edges of the openings 102 of the shadow mask 101 so that the organic EL material is vapor-deposited in an outer region of the openings 102. Furthermore, density of the vapor-deposition beams is lowered, especially at the edges of the openings 102 rather than a center thereof. This makes each thickness of the vapor-deposited organic EL material layers 200 non-uniform, that is, high at the center and low at the periphery, thereby providing a possibility of damaging properties of the organic EL element 60 (as shown in FIG. 12B).

### SUMMARY OF THE INVENTION

The invention provides a manufacturing method of an organic electroluminescent display device. The method includes providing a vapor-deposition beam generator having a plurality of vapor-deposition beam passing pipes and containing therein an electroluminescent material. The pipes are aligned substantially parallel to each other. The method also includes placing a substrate in a vacuum chamber, placing a vapor-deposition mask having a plurality of openings adjacent a surface of the substrate, and vapor-depositing the organic electroluminescent material on a predetermined region of the surface of the substrate through the openings in the vapor deposition mask by generating vapor-deposition beams that are regulated by the vapor-deposition beam passing pipes.

The invention also provides a manufacturing method of an organic electroluminescent display device. The method includes placing a substrate in a vacuum chamber, placing a vapor-deposition mask having a plurality of openings adjacent a surface of the substrate, placing a vapor-deposition beam generator for generating vapor-deposition beams containing an organic electroluminescent material so as to face the vapor-deposition mask, and placing a vapor-deposition beam direction adjusting board having a plurality of vapor-deposition beam passing holes between the vapor-deposition beam generator and the vapor-deposition mask. The holes are aligned substantially parallel to each other. The method also includes vapor-depositing the organic electroluminescent material on a predetermined region of the surface of the substrate by generating the vapor-deposition beams containing the organic electroluminescent material and by leading the beams through the vapor-deposition beam passing holes of the vapor-deposition beam direction adjusting board and through the openings of the vapor-deposition mask.

The invention further provides a deposition method that includes placing a deposition source containing a deposition material in a vacuum chamber, placing a substrate in the vacuum chamber, placing a vapor-deposition mask having a plurality of openings between the deposition source and the substrate, and evaporating the deposition material from the deposition source so as to form a flux of the deposition material. The method also includes forming a substantially collimated beam of the evaporation material by forcing at least part of the flux to pass through a conduit, and directing the collimated beam through the openings of the vapor-deposition mask to the substrate.

### BRIEF DESCRIPTION OF THE DRAWINGS

FIG. 1 is a perspective view of a vapor-deposition beam generator to be used for a manufacturing method of an organic EL element according to a first embodiment of the invention.

FIG. 2 is a cross-sectional view of the vapor-deposition beam generator to be used for the manufacturing method of the organic EL element according to the first embodiment of the invention.

FIG. 3 is an explanatory view of a manufacturing method of an organic EL display device according to the first embodiment of the invention.

FIG. 4 is an explanatory view of the manufacturing method of the organic EL display device according to the first embodiment of the invention.

FIGS. 5A and 5B are explanatory views of the manufacturing method of the organic EL display device according to the first embodiment of the invention.

FIG. 6 is a perspective view of a vapor-deposition beam generator to be used for a manufacturing method of an organic EL element according to a second embodiment of the invention.

FIG. 7 is a cross-sectional view of the vapor-deposition beam generator to be used for the manufacturing method of the organic EL element according to the second embodiment of the invention.

FIG. 8 is an explanatory view of a manufacturing method of an organic EL display device according to the second embodiment of the invention.

FIG. 9 is an explanatory view of the manufacturing method of the organic EL display device according to the second embodiment of the invention.

FIGS. 10A and 10B are explanatory views of the manufacturing method of the organic EL display device according to the second embodiment of the invention.

FIG. 11 is a cross-sectional view of a pixel of an organic EL display device according to the conventional art.

FIGS. 12A and 12B are explanatory views of a manufacturing method of the organic EL display device according to the conventional art.

### DETAILED DESCRIPTION OF THE INVENTION

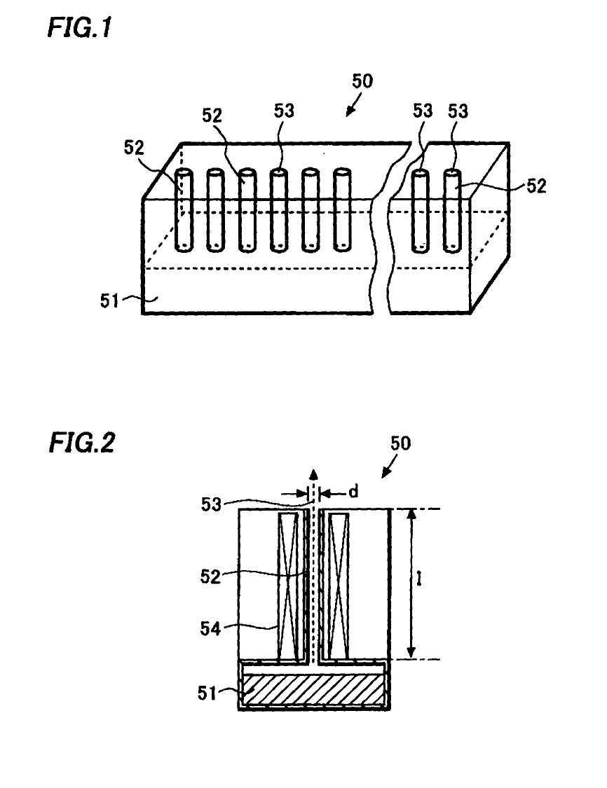

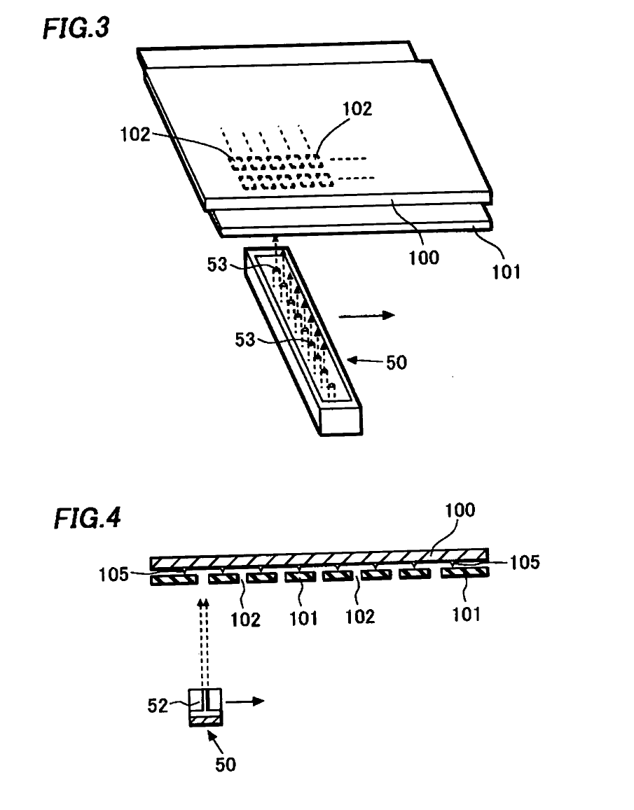

A first embodiment of the invention will be described with reference to the drawings in detail. FIG. 1 is a perspective view of a vapor-deposition beam generator 50, FIG. 2 is a cross-sectional view of FIG. 1, FIG. 3 is a perspective view showing a vapor-deposition process of an organic EL material, and FIG. 4 is a cross-sectional view of FIG. 3.

In a manufacturing method of an organic EL display device of the first embodiment, the insulating substrate 10 is prepared, and the TFT for driving an organic EL element and the organic EL element 60 are sequentially formed on the insulating substrate 10. This is the same as the process described in the related art except the process of forming the organic EL element 60.

The hole transport layer 62, the emissive layer 63, the electron transport layer 64, and the cathode 65 of the organic EL element 60 are patterned by a vapor-deposition method with the shadow mask 101. Vapor-deposition beams are enhanced in its directional uniformity through vapor-deposition beam passing pipes 52 which are long and narrow and attached to the vapor-deposition beam generator 50.

The vapor-deposition beam generator 50 is provided with storage 51 for storing the organic EL material on a bottom of a box having a predetermined shape, as shown in FIGS. 1 and 2. Although not shown, a heater is provided in the storage 51 so that the organic EL material stored in the storage 51 is heated to be in a molten state.

Above the storage 51, the plurality of the vapor-deposition beam passing pipes 52, which is long and narrow and communicates with the storage 51, is provided in a row along a longitudinal direction of the box. A heater 54 for heating the vapor-deposition beams which pass through the vapor-deposition beam passing pipes 52 is attached adjacent each of the vapor-deposition beam passing pipes 52. Nozzles 53 of the vapor-deposition beam passing pipes 52 are exposed, being in plane with an upper surface of the box.

A ratio of a pipe diameter d to a pipe length l of each of the vapor-deposition beam passing pipes 52 needs to be at least 1:5. This is for enhancing directional uniformity of the vapor-deposition beams and securing uniformity in a layer thickness and precision of pattern formation of the vapor-deposited organic EL material layers, i.e., the hole transport layer 62, the emissive layer 63, the electron transport layer 64, and the cathode 65. Furthermore, in consideration of dispersion and repeatability of the vapor-deposition beams, the ratio of the pipe diameter d to the pipe length l is preferably at least 1:10.

Although the vapor-deposition beam passing pipes 52 are preferably in a cylindrical shape for smoothly guiding the vapor-deposition beams of high directional uniformity, it is not restricted to this shape but can be in a prism shape or other shapes. When the ratio of the pipe diameter d to the pipe length l of the vapor-deposition beam passing pipe 52 is 1:5, for example, the vapor-deposition beam passing pipe 52 is preferably 0.5 mm in diameter d and 2.5 mm in length l in practice.

Then, as shown in FIGS. 3 and 4, the insulating substrate 100 having the TFT for driving the organic EL element or the like is disposed in a vacuum chamber, and the shadow mask 101 is disposed adjacent and opposite to the insulating substrate 100.

The openings 102 are formed correspondingly to each pattern of organic EL material layers. The vapor-deposition beam generator 50 is disposed opposite to the shadow mask 101. The molten organic EL material stored in the storage 51 of the vapor-deposition beam generator 50 is vaporized, passes through the vapor-deposition beam passing pipes 52 to be the vapor-deposition beams of high directional uniformity, and is guided to the shadow mask 101. The vapor-deposition beam generator 50 is moved in parallel with the shadow mask 101 so that the vapor-deposition beams are led to the whole surface of the shadow mask 101. Accordingly, the patterns of the organic EL material layers are each formed.

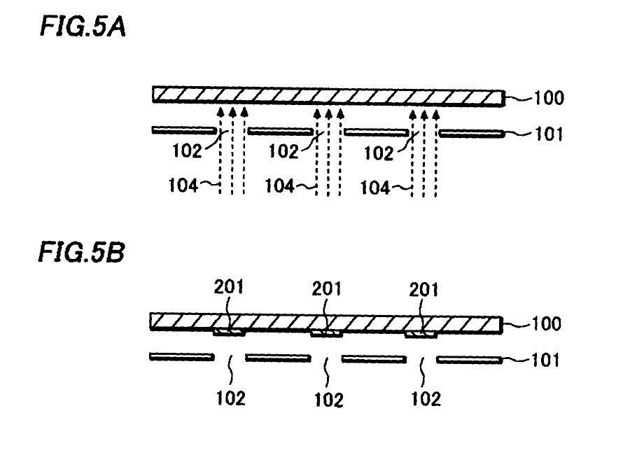

FIGS. 5A and 5B show the state in which the vapor-deposition beams 104 are led to the insulating substrate 100 through the shadow mask 101. As shown in FIG. 5A, the vapor-deposition beams 104 all travel in the same direction perpendicular to the shadow mask 101 and the insulating substrate 100. Therefore, a shadow effect does not occur and vapor-deposition in an outer region of the opening 102 is prevented. The thickness of the vapor-deposited organic EL material 201 is uniform at any position.

When the shadow mask 101 is disposed adjacent and opposite to the insulating substrate 100, it is preferable to dispose a plurality of spacers 105 between the insulating substrate 100 and the shadow mask 101 (shown in FIG. 4) in order to provide a predetermined space (for example, several ten micrometers) therebetween. This prevents the insulating substrate 100 from contacting the shadow mask 101 and being damaged at its film or elements on the surface.

Additionally, the organic EL material layer includes a plurality of layers such as the hole transport layer 62, the emissive layer 63, the electron transport layer 64, and the cathode 65. After vapor-depositing the hole transport layer 62 in one vacuum chamber, for example, the insulating substrate 100 vapor-deposited with the hole transport layer 62 is transferred to other vacuum chamber, and the emissive layer 63 is formed on the hole transport layer 62 by repeating the similar process. Accordingly, the hole transport layer 62, the emissive layer 63, the electron transport layer 64, and the cathode 65 are sequentially laminated to form the organic EL element 60.

Incidentally, although the plurality of the vapor-deposition beam passing pipes 52 is formed standing in a row along a longitudinal direction of the box as a linear source in the described first embodiment, the invention is not restricted to this but the vapor-deposition beam passing pipes 52 can be disposed in a matrix form.

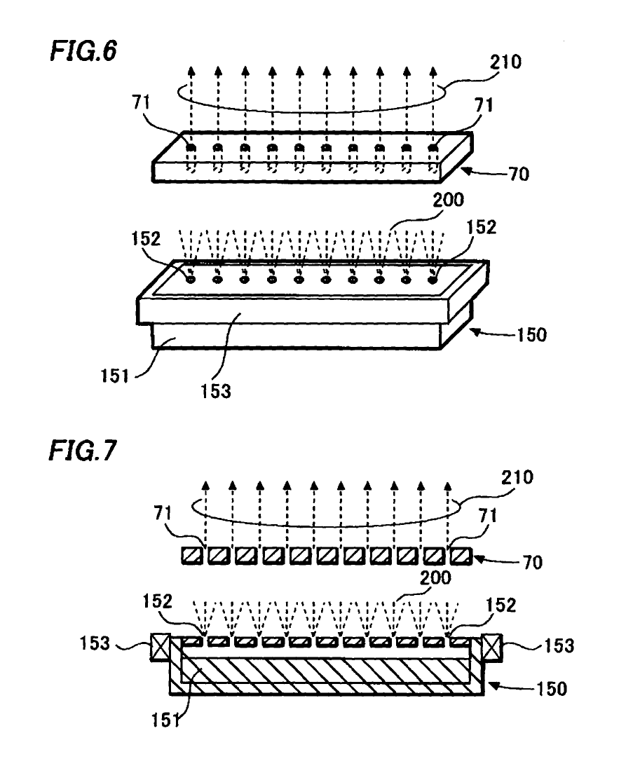

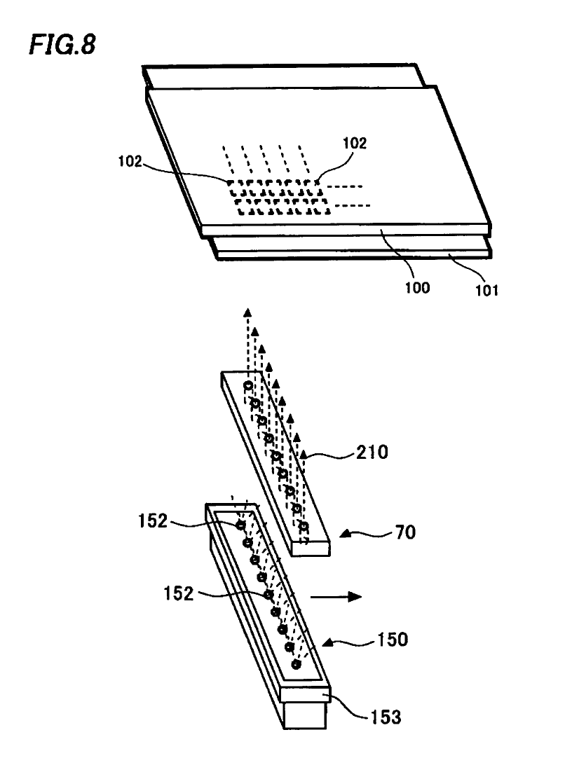

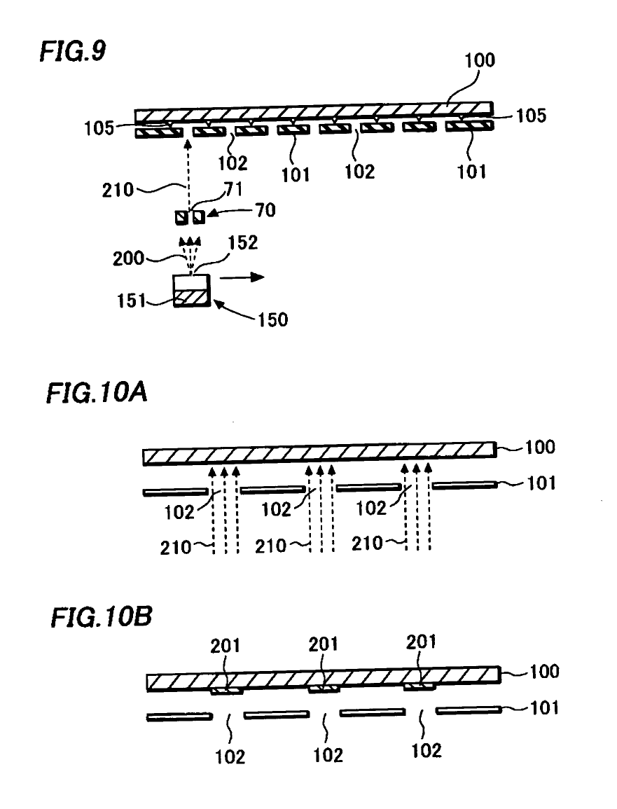

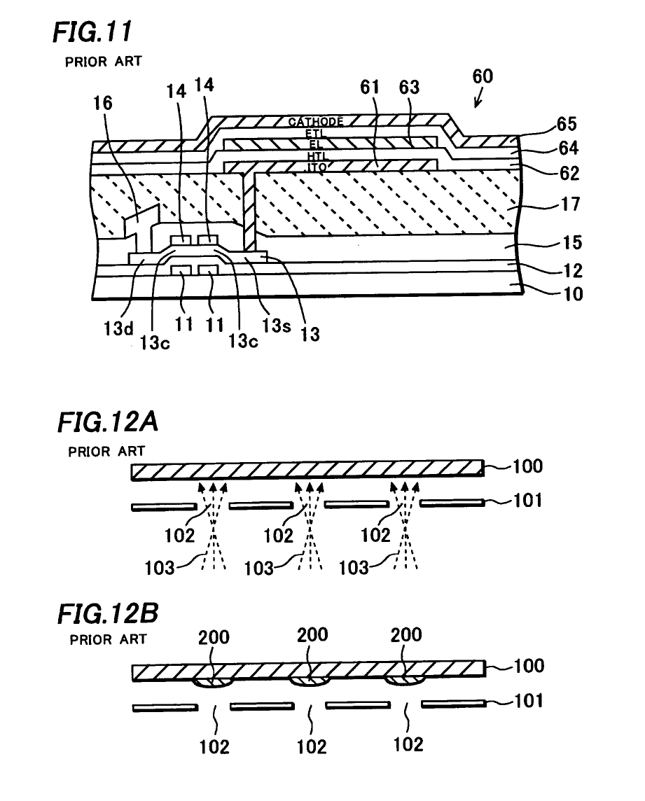

Next, a second embodiment of the invention will be described with reference to the drawings in detail. FIG. 6 is a perspective view of a vapor-deposition beam direction adjusting board 70 provided opposite to a vapor-deposition beam generator 150, and FIG. 7 is a cross-sectional view of FIG. 6. FIG. 8 is a perspective view showing a vapor-deposition process of the organic EL material, and FIG. 9 is a cross-sectional view of FIG. 8.

In a manufacturing method of an organic EL display device of the second embodiment, the insulating substrate 10 is prepared, and the TFT for driving the organic EL element and the organic EL element 60 are sequentially formed on the insulating substrate 10. This process is the same as the process described in the related art except the process of forming the organic EL element 60.

The hole transport layer 62, the emissive layer 63, the electron transport layer 64, and the cathode 65 of the organic EL element 60 are patterned by the vapor-deposition method with the shadow mask 101.

In the vapor-deposition beam generator 150, storage 151 for storing the organic EL material is provided at a bottom of a box having a predetermined shape, as shown in FIGS. 6 and 7.

The storage 151 is provided with a heater 153 so that the organic EL material stored in the storage 151 can be in a molten state by heating. Above the storage 151, a plurality of vapor-deposition beam irradiating holes 152 is formed in a row along a longitudinal direction of the box. The vapor-deposition beams are irradiated from the plurality of the vapor-deposition beam irradiating holes 152 formed in the vapor-deposition beam generator 150. Vapor-deposition beams 200 coming out of the vapor-deposition beam irradiating holes 152 pass through a plurality of vapor-deposition beam passing holes 71 in the vapor-deposition beam direction adjusting board 70 provided opposite to the vapor-deposition beam irradiating holes 152 in the vapor-deposition beam generator 150, thereby forming vapor-deposition beams 210 having high directional uniformity.

The number of the vapor-deposition beam irradiating holes 152 is not necessarily the same as that of the vapor-deposition beam passing holes 71. Although the vapor-deposition beam passing holes 71 are preferably in a cylindrical shape formed by hollowing out the vapor-deposition beam direction adjusting board 70, those are not restricted to this but can be in a prism shape formed by hollowing out the vapor-deposition beam direction adjusting board 70.

A diameter of the vapor-deposition beam passing hole 71 is approximately 0.1 to 1 mm to enhance the directional uniformity well.

The vapor-deposition beam direction adjusting board 70 is preferably provided with a heating element such as a heater (not shown) and heated. The vapor-deposition beam direction adjusting board 70 may include the heating element. Accordingly, the vapor-deposition beams 210 passing through the plurality of the vapor-deposition beam passing holes 71 in the vapor-deposition beam direction adjusting board 70 are heated, thereby preventing the vapor-deposition material from adhering to the vapor-deposition beam passing holes 71.

As shown in FIGS. 8 and 9, the insulating substrate 100 formed with the TFT for driving the organic EL element or the like is disposed in a vacuum chamber, and the shadow mask 101 is disposed adjacent and opposite to this insulating substrate 100.

The shadow mask 101 is formed with the plurality of the openings 102 correspondingly to the patterns of the organic EL material layers. The above described vapor-deposition beam generator 150 is disposed opposite to the shadow mask 101. Furthermore, the vapor-deposition beam direction adjusting board 70 provided with the plurality of the vapor-deposition beam passing holes 71 is disposed opposite to the vapor-deposition beam generator 150.

The organic EL material in a molten state which is stored in the storage 151 of the vapor-deposition beam generator 150 is vaporized so that the vapor-deposition beams 200 come out of the vapor-deposition beam irradiating holes 152. The vapor-deposition beams 200 pass through the vapor-deposition beam passing holes 71 in the vapor-deposition beam direction adjusting board 70 provided opposite to the vapor-deposition beam irradiating holes 152 to become the vapor-deposition beams 210 having high directional uniformity, thereby irradiating the shadow mask 101. The vapor-deposition beam generator 150 and the vapor-deposition beam direction adjusting board 70 are simultaneously moved in parallel with the shadow mask 101 so that the vapor-deposition beams 210 having high directional uniformity are incident on the whole surface of the shadow mask 101, thereby forming the patterns of the organic EL material layers.

Incidentally, although the vapor-deposition beam generator 150 and the vapor-deposition beam direction adjusting board 70 are not connected when simultaneously moved in parallel with the shadow mask 101 in FIGS. 8 and 9, those may be physically connected as an integral unit. Since the vapor-deposition beam generator 150 and the vapor-deposition beam direction adjusting board 70 can be moved relatively to the shadow mask 101, the vapor-deposition beam generator 150 and the vapor-deposition beam direction adjusting board 70 may be stationary and the insulating substrate 100 and the shadow mask 101 may move instead.

FIGS. 10A and 10B show the state in which the vapor-deposition beams 210 are guided to the insulating substrate 100 through the shadow mask 101. As shown in FIG. 10A, all the directions of the vapor-deposition beams 210 are almost vertical to the shadow mask 101 and the insulating substrate 100, thereby eliminating the shadow effect and preventing vapor-deposition in an outer region of the openings 102. Furthermore, a thickness of the vapor-deposited organic EL material 201 is uniform at any position.

When the shadow mask 101 is disposed adjacent and opposite to the insulating substrate 100, it is preferable to provide the spacers 105 between the insulating substrate 100 and the shadow mask 101 in order to secure a predetermined space (for example, several ten micrometers). This prevents the insulating substrate 100 from contacting the shadow mask 101 and from being damaged at its film or elements on the surface.

Additionally, the organic EL material layer includes a plurality of layers such as the hole transport layer 62, the emissive layer 63, the electron transport layer 64, and the cathode 65. After vapor-depositing the hole transport layer 62 in one vacuum chamber, for example, the insulating substrate 100 vapor-deposited with the hole transport layer 62 is transferred to other vacuum chamber, and the emissive layer 63 is formed on the hole transport layer 62 by repeating the similar process. Accordingly, the hole transport layer 62, the emissive layer 63, the electron transport layer 64, and the cathode 65 are sequentially laminated to form the organic EL element 60.

Incidentally, although the plurality of the vapor-deposition beam irradiating holes 152 and the vapor-deposition beam passing holes 71 are formed standing in a row along a longitudinal direction of the box as a linear source in the described second embodiment, the invention is not restricted to this but the vapor-deposition beam irradiating holes 152 and the vapor-deposition beam passing holes 71 can be disposed in a matrix.

What is claimed is:

1. A manufacturing method of an organic electroluminescent display device, comprising:
providing a vapor-deposition beam generator comprising a plurality of vapor-deposition beam passing pipes and containing therein an electroluminescent material, the pipes being aligned substantially parallel to each other;
placing a substrate in a vacuum chamber;
placing a vapor-deposition mask having a plurality of openings adjacent a surface of the substrate; and
vapor-depositing the organic electroluminescent material on a predetermined region of the surface of the substrate through the openings in the vapor deposition mask by generating vapor-deposition beams that are regulated by the vapor-deposition beam passing pipes.

2. The manufacturing method of claim 1, wherein a ratio of a diameter of the pipes to a length of the pipes is 1:5 or greater.

3. The manufacturing method of claim 1, wherein the vapor-depositing comprises heating the vapor-deposition beams while the beams pass through the vapor-deposition beam passing pipes.

4. A manufacturing method of an organic electroluminescent display device, comprising:
placing a substrate in a vacuum chamber;
placing a vapor-deposition mask having a plurality of openings adjacent a surface of the substrate;
placing a vapor-deposition beam generator for generating vapor-deposition beams containing an organic electroluminescent material so as to face the vapor-deposition mask;
placing a vapor-deposition beam direction adjusting board having a plurality of vapor-deposition beam passing holes between the vapor-deposition beam generator and the vapor-deposition mask, the holes being aligned substantially parallel to each other; and
vapor-depositing the organic electroluminescent material on a predetermined region of the surface of the substrate by generating the vapor-deposition beams containing the organic electroluminescent material and by leading the beams through the vapor-deposition beam passing holes of the vapor-deposition beam direction adjusting board and through the openings of the vapor-deposition mask.

5. The manufacturing method of claim 4, wherein the vapor-deposition beam passing holes are provided in a row along a longitudinal direction of the vapor-deposition beam direction adjusting board.

6. The manufacturing method of claim 4, further comprising heating the vapor-deposition beam direction adjusting board.

7. The manufacturing method of claim 4, wherein the vapor-deposition beam direction adjusting board comprises a heating element.

8. A deposition method comprising:
placing a deposition source containing a deposition material in a vacuum chamber;
placing a substrate in the vacuum chamber;
placing a vapor-deposition mask having a plurality of openings between the deposition source and the substrate;
evaporating the deposition material from the deposition source so as to form a flux of the evaporation material;
forming a substantially collimated beam of the deposition material by forcing at least part of the flux to pass through a conduit; and
directing the collimated beam through the openings of the vapor-deposition mask to the substrate.

9. The deposition method of claim 8, wherein the substrate comprises a plurality device elements formed thereon, the forming the collimated beam comprises forming a plurality of the collimated beams, and the directing collimated beam comprises directing the plurality of the collimated beams to corresponding device elements of the substrate.
